(19) United States
(12) Patent Application Publication
(10) Pub. No.: US 2020/0014808 A1
(43) Pub. Date: Jan. 9, 2020

(54) Image Processing Apparatus, Image Processing System and Storage Medium

(71) Applicant: KONICA MINOLTA, INC., Tokyo (JP)

(72) Inventor: Shimpei Itaya, Tokyo (JP)

(73) Assignee: KONICA MINOLTA, INC., Tokyo (JP)

(21) Appl. No.: 16/437,039

(22) Filed: Jun. 11, 2019

(30) Foreign Application Priority Data
Jul. 4, 2018 (JP) 2018-127220

(51) Int. Cl. H04N 1/00; H04N 1/32

(52) U.S. Cl. CPC H04N 1/00427; H04N 1/00912; H04N 1/00832; H04N 2201/0094; H04N 2201/3274; H04N 1/32101

(57) ABSTRACT

An image processing apparatus includes the following. A communicator performs data communication with a terminal apparatus. A hardware processor provides through the communicator to the terminal apparatus screen information to form a display screen displayed on a display of the image processing apparatus, and displays the display screen with a browser of the terminal apparatus. The screen information includes the following. Functional information shows a function included in the image processing apparatus. An information analysis program allows a computer of the terminal apparatus to function as a functional information extractor which extracts functional information of the image processing apparatus from the screen information, a functional difference specifier which specifies the functional difference between the image processing apparatus and another image processing apparatus based on the functional information, and a display controller which controls the display to display the functional difference on the display screen.

### BACKGROUND

### 1. Technological Field

The present invention relates to an image processing apparatus, an image processing system and a storage medium.

### 2. Description of the Related Art

Lately, image processing apparatuses called multi-function peripherals (MFP) are widely used. Such apparatuses include various functions such as copying, scanning, faxing, and managing documents.

There is also a technique to connect such image processing apparatuses to terminal apparatuses such as a tablet-type computer or a smartphone to be able to communicate with each other through a network in order to allow the image processing apparatus to execute a predetermined process based on operation by remote control from the terminal apparatus. Specifically, the image processing apparatus provides the user interface displayed on the touch panel display to the terminal apparatus through the network so that the user interface is displayed on the display of the terminal apparatus. The user is able to operate the image processing apparatus remotely by operating the operating button on the user interface.

Here, the user is able to select the image processing apparatus which performs the process from among the plurality of image processing apparatuses provided on the same network. Different functions may be provided in each image processing apparatus, and even if the functions are the same, there may be differences in the performance of the function depending on the image processing apparatus. Therefore, preferably, the user compares the functions and selects the image processing apparatus to be used.

Japanese Patent Application Laid-Open Publication No. 2008-173847 discloses a technique in which the differences in functions among the image processing apparatuses are clarified so that the user can make a selection easily. Specifically, the user installs a printing application in the terminal apparatus and refers to functional information of the image processing apparatus connected to the terminal apparatus on the printing application. Here, the image processing apparatus communicates with other image processing apparatuses provided on the network to obtain the functional information of the other image processing apparatuses. Then, the functions unique to the certain image processing apparatus is displayed on the screen of the printing application. With this, the user is able to select the image processing apparatus based on the display. Consequently, the convenience is enhanced.

According to the method described in Japanese Patent Application Laid-Open Publication No. 2008-173847, the printing application needs to be installed. However, to install a dedicated printing apparatus in each terminal apparatus such as smartphone or personal computer is troublesome to the user.

### SUMMARY

The object of the present invention is to provide an image processing apparatus, an image processing system, and a storage medium with which it is possible to confirm differences in functions among image processing apparatuses using a simple method in an image processing apparatus which executes processes based on requests from terminal apparatuses.

To achieve at least one of the abovementioned objects, according to an aspect of the present invention, an image processing apparatus reflecting one aspect of the present invention is described, the image processing apparatus which includes a function to perform processes based on a request from a terminal apparatus, the image processing apparatus including: a communicator which performs data communication with the terminal apparatus; and a hardware processor which provides through the communicator to the terminal apparatus screen information to form a display screen displayed on a display of the image processing apparatus, and which displays the display screen with a browser of the terminal apparatus, wherein, the screen information includes, functional information which shows a function included in the image processing apparatus; and an information analysis program which allows a computer of the terminal apparatus to function as a functional information extractor which extracts functional information of the image processing apparatus from the screen information, a functional difference specifier which specifies the functional difference between the image processing apparatus and another image processing apparatus based on the functional information, and a display controller which controls the display to display the functional difference on the display screen.

According to another aspect of the present invention, the image processing system includes: a terminal apparatus; and an image processing apparatus which includes a function to perform a process based on a request from the terminal apparatus, wherein the image processing apparatus includes: a communicator which performs data communication with the terminal apparatus; and a hardware processor which provides through the communicator to the terminal apparatus screen information to form a display screen displayed on a display of the image processing apparatus, and which displays the display screen with a browser of the terminal apparatus, wherein, the screen information includes, functional information which shows a function included in the image processing apparatus; and an information analysis program which allows a computer of the terminal apparatus to function as a functional information extractor which extracts functional information of the image processing apparatus from the screen information, a functional difference specifier which specifies the functional difference between the image processing apparatus and another image processing apparatus based on the functional information, and a display controller which controls the display to display the functional difference on the display screen, and the terminal apparatus performs the information analysis program included in the screen information.

According to another aspect of the present invention, a non-transitory computer-readable storage medium having a program stored thereon for controlling a computer in an image processing apparatus which includes a function to perform a process based on a request from a terminal apparatus and a communicator which performs data communication with the terminal apparatus, wherein the program controls the computer to perform: providing through the communicator to the terminal apparatus screen information to form a display screen displayed on a display of the image processing apparatus, and displaying the display screen with a browser of the terminal apparatus, wherein, the screen information includes, functional information which shows a function included in the image processing apparatus; and an information analysis program which allows a computer of the terminal apparatus to function as a functional information extractor which extracts functional information of the image processing apparatus from the screen information, a functional difference specifier which specifies the functional difference between the image processing apparatus and another image processing apparatus based on the functional information, and a display controller which controls the display to display the functional difference on the display screen.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing a schematic configuration of an image processing system.

FIG. 2 is a diagram showing an example of a hardware configuration of an image processing apparatus.

FIG. 3 is a diagram showing an example of a hardware configuration of a personal computer (PC).

FIG. 4 is a diagram showing an example of a hardware configuration of a portable terminal.

FIG. 5 is a diagram showing an example of a display screen displayed on a touch panel display of the image processing apparatus.

FIG. 6 is a diagram showing an example of a display screen displayed on a Web page of the PC.

FIG. 7 is a diagram showing a functional configuration of the PC.

FIG. 8A is a diagram showing an example of a display screen displayed on the Web page of the PC.

FIG. 8B is a diagram showing an example of a display screen displayed on the Web page of the PC.

FIG. 9 is a flowchart showing a procedure of each apparatus of the image processing system according to a first embodiment.

FIG. 10 is a flowchart showing a procedure in a screen information analysis.

FIG. 11 is a diagram showing an example of a display screen displayed on the Web page of the PC.

FIG. 12 is a diagram showing an example of a display screen displayed on the Web page of the PC.

FIG. 13 is a flowchart showing a procedure of each apparatus of the image processing system according to a second embodiment.

### DETAILED DESCRIPTION OF EMBODIMENTS

Hereinafter, one or more embodiments of the present invention will be described with reference to the drawings. The embodiments described below include various technically preferable limitations to implement the present invention. However, the scope of the invention is not limited to the disclosed embodiments.

### First Embodiment

A first embodiment of the image processing system is described with reference to the drawings. The present invention is not limited to the illustrated examples.

[Configuration of Image Processing System]

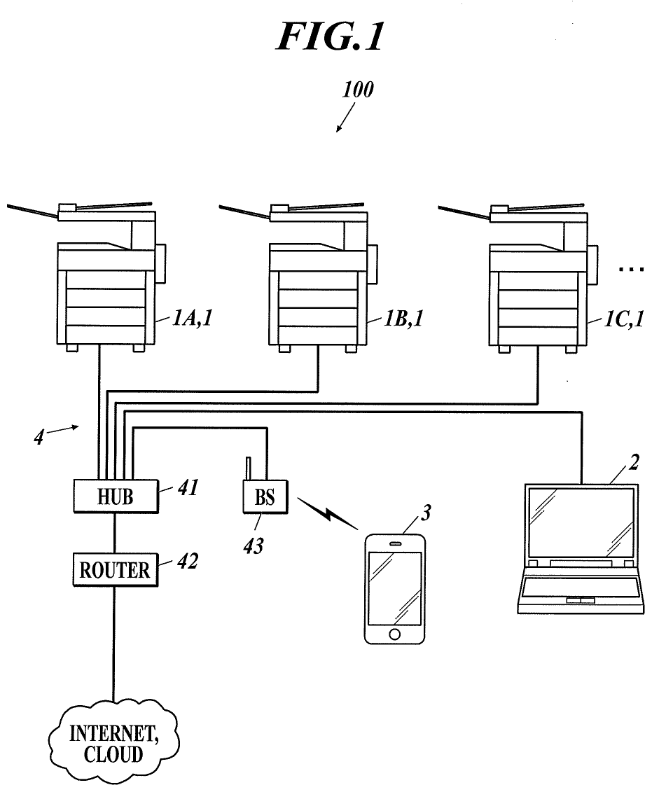

FIG. 1 is a diagram showing an example of an entire configuration of the image processing system 100.

As shown in FIG. 1, the image processing system 100 includes image processing apparatuses 1A (1), 1B (1), 1C (1) . . . , Personal Computer (PC) 2, portable terminal 3, and communication line 4.

The number of image processing apparatuses 1 included in the image processing system 100 may be any number as long as the number is two or more.

The image processing apparatus 1 is able to communicate with other image processing apparatuses 1, the PC 2 and the portable terminal 3 through the communication line 4. The internet, Local Area Network (LAN), public lines or a dedicated line may be used as the communication line 4, and a hub 41, a router 42 and a wireless base station 43 are provided.

The router 42 connects the LAN to other networks such as the internet. The wireless base station 43 is a base station (BS) of the wireless LAN and communicates with a wireless LAN communication apparatus 30f of the portable terminal 3.

The wireless base 43 and the image processing apparatuses 1 are connected to a hub 41 by a twisted pair cable. The hub 41 is connected to the router 42 by the twisted pair cable. There may be a plurality of hubs 41 and wireless base stations 43.

The image processing apparatus 1 provides services such as scan, copy, print, e-mail, fax, and box storage. Image processing apparatuses including such functions are typically called multi-function peripherals.

The scan service is a service which reads an image on a sheet with a scanning unit 10i later described to generate image data.

The copy service is a service which prints the image on the sheet based on the image data obtained by reading the image with the scanning unit 10i.

The PC print service is a service which prints the image on the sheet based on the image data received from the PC 2 or the portable terminal 3. This may also be called network printing or network print.

The mail service is a service which transmits the image data obtained by reading the image with the scanning unit 10i to a specified e-mail address.

The fax service is a service which transmits the image data obtained by reading the image with the scanning unit 10i to an external facsimile terminal.

The box storage service is a service which provides a storage region called a box or a personal box to each user so that each user stores and manages image data in his own storage region. The box corresponds to the folder or directory in the personal computer.

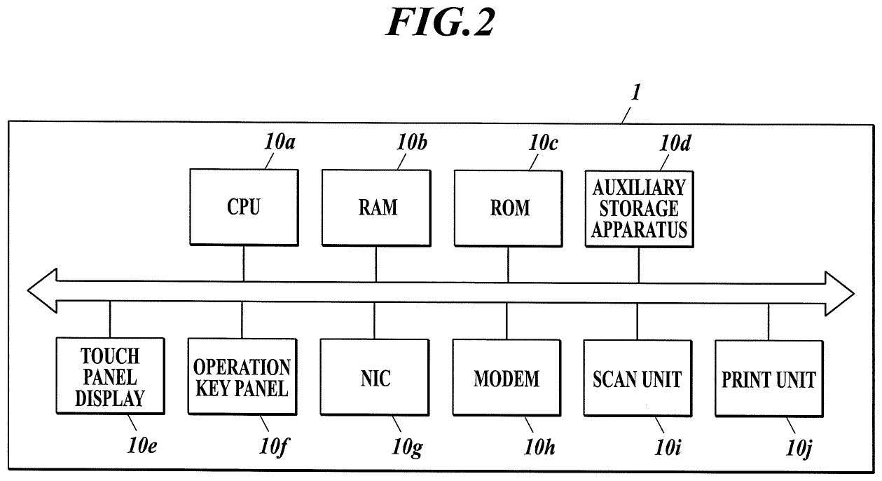

FIG. 2 is a diagram showing an example of a hardware configuration of the image processing apparatus.

As shown in FIG. 2, the image processing apparatus 1 includes a Central Processing Unit (CPU) 10a, Random Access Memory (RAM) 10b, Read Only Memory (ROM) 10c, auxiliary storage apparatus 10d, touch panel display 10e, operation key panel 10f, Network Interface Card (NIC) 10g, modem 10h, scanning unit 10i, and print unit 10j.

The auxiliary storage apparatus 10d is a storage apparatus including a Hard Disc Drive (HDD) or a Solid State Drive (SSD) and stores programs to control the procedures in each unit of the image processing apparatus 1 and a Web browser program to realize the Web browser.

The auxiliary storage apparatus 10d stores programs such as the following, a Web server program to realize the function as the Web server which communicates with the Web browser included in the terminal apparatus (PC 2, portable terminal 3 or other image processing apparatus 1) through communication by HTTP protocol in order to provide the user interface (UI) to the Web browser, and an application program which operates on the Web server to provide the Web UI (Web user interface) function of the image processing apparatus 1 to the user through the Web browser.

The Web UI is an interface which enables the user to operate the image processing apparatus 1 by remote control through the terminal apparatus by displaying the display screen displayed on the touch panel display 10e on the terminal apparatus (PC 2, terminal apparatus 3 or other image processing apparatus 1).

The programs are loaded on the RAM 10b as necessary and executed by the CPU 10a.

The touch panel display 10e includes a monitor such as a Cathode Ray Tube (CRT) or a Liquid Crystal Display (LCD), and displays various screens such as a screen showing a message to the user, a screen for the user to input a command or information and a screen showing a result of processing performed by the CPU 10a. The touch panel display 10e transmits the signal showing the touched position to the CPU 10a.

The touch panel display 10e functions as the display.

The operation key panel 10f is a hardware keyboard and includes numeric keys, a start key, a stop key, and function keys.

The NIC 10g uses the protocol such as TCP/IP (Transmission Control Protocol/Internet Protocol) to perform communication with other image processing apparatuses 1, the PC 2 or the portable terminal 3 through the communication line 4.

The NIC 10g functions as the communicator.

The modem 10h communicates image data with the external facsimile terminal using the protocol such as G3.

The scanning unit 10i includes a CCD (Charge Coupled Device), platen glass, etc. and uses the CCD to read the image described on the sheet set on the platen glass to generate the image data.

In addition to the image read by the scanning unit 10i, the print unit 10j prints the image received from other apparatuses with the NIC 10g or the modem 10h on the sheet.

Next, the PC 2 is described.

The PC 2 is a client in order to remotely use the above-described functions of the image processing apparatus 1 and functions as the terminal apparatus. The user is able to operate by remote control the above-described various functions of the image processing apparatus 1 using the PC 2.

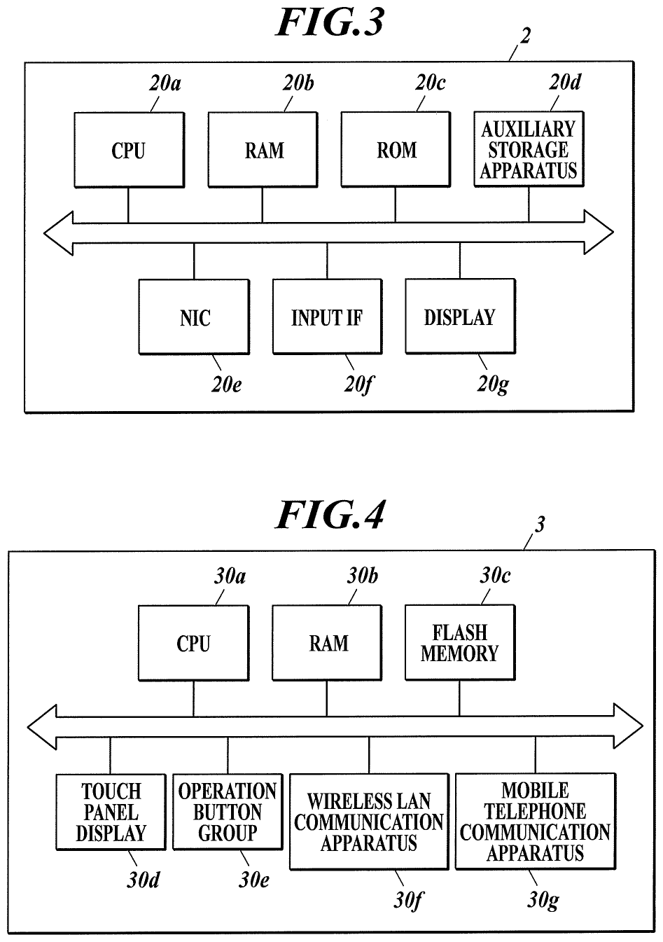

FIG. 3 is a diagram showing an example of the hardware configuration of the PC 2.

As shown in FIG. 3, the PC 2 includes a CPU 20a, RAM 20b, ROM 20c, auxiliary storage apparatus 20d, NIC 20e, input IF (Interface) 20f, and display 20g.

The CPU 20a functions as an executer and functions as the functional information extractor, access detector, functional difference specifier, and display controller in coordination with the information analysis program.

The auxiliary storage apparatus 20d is a storage apparatus including a HDD or SSD and stores a program to control the procedures of each unit in the PC 2.

Further, the auxiliary storage apparatus 20d stores a Web browser program to realize the Web browser and an application program to receive the provided Web UI function.

Each program is loaded on the RAM 20b as necessary and performed by the CPU 20a.

The NIC 20e performs communication with the image processing apparatus 1 through the communication line 4 by using the protocol such as TCP/IP.

The input IF 20f detects the operation by input devices such as a keyboard or a mouse, and notifies the information to the CPU 20a.

The display 20g includes a monitor such as a CRT or LCD and displays a screen showing a message to the user, a screen for the user to input a command or information, and a screen showing a result of processing performed by the CPU 20a. The display 20g displays a display screen of the image processing apparatus through the Web browser.

Next, the portable terminal 3 is described.

The portable terminal 3 is a client to use by remote control the above-described functions of the image processing apparatus 1 and functions as the terminal apparatus. The user is able to operate by remote control the above-described various functions of the image processing apparatus 1 by using the portable terminal 3, similar to the PC 2.

Portable apparatuses such as a smartphone or tablet computer are used as the portable terminal 3.

FIG. 4 is a diagram showing an example of a hardware configuration of a portable terminal 3.

As shown in FIG. 4, the portable terminal 3 includes a CPU 30a, a RAM 30b, a flash memory 30c, a touch panel display 30d, an operation button group 30e, a wireless LAN communication apparatus 30f and a mobile telephone communication apparatus 30g.

The flash memory 30c stores an application program for creating documents (for example, word processing software) or application programs for e-mail and schedules.

The flash memory 30c stores the Web browser program to realize the Web browser and the application program to receive the provided Web UI.

Each program is loaded on the RAM 30b as necessary and is performed by the CPU 30a.

Similar to the touch panel display 10e of the image processing apparatus 1, the touch panel display 30d displays various screens and detects the touched position to notify the position to the CPU 30a.

The operation button group 30e includes the following buttons such as a button to return to the home screen, a button to adjust the volume, and a button to switch the power to ON or OFF.

The wireless LAN communication apparatus 30f performs communication based on the standard of the wireless LAN, that is, the standard of IEEE (Institute of Electrical Engineers) 802.11.

The mobile telephone communication apparatus 30g performs communication through the mobile phone network based on standards such as CDMA (Code Division Multiple Access) 2000, W-CMDA (Wideband-CMDA), or LTE (Long Term Evolution).

[Screen Information]

Below, the screen information generated by the image processing apparatus 1 according to the present embodiment is described with reference to the drawings.

In the example described below, the PC 2 is used as the terminal apparatus. The same description applies when the portable terminal 3 is used as the terminal apparatus or when the other image processing apparatuses 1 are used as the terminal apparatus.

The screen information is information for generating the display screen displayed on the touch panel display 10e of the image processing apparatus 1. The screen information is data including functional information showing information regarding the functions included in the image processing apparatus 1 and the information regarding the performance of the functions, and an information analysis program which extracts the functional information from the screen information, which analyzes the functional information and which controls the display of the display screen 11 according to the analysis result. The description of the functional information and the information analysis program is described later.

The screen information is described in a language which can be used by the Web browser such as HTML (Hyper Text Markup Language) and JavaScript (registered trademark). With this, the display screen is displayed on the touch panel display 10e of the image processing apparatus 1 through the Web browser.

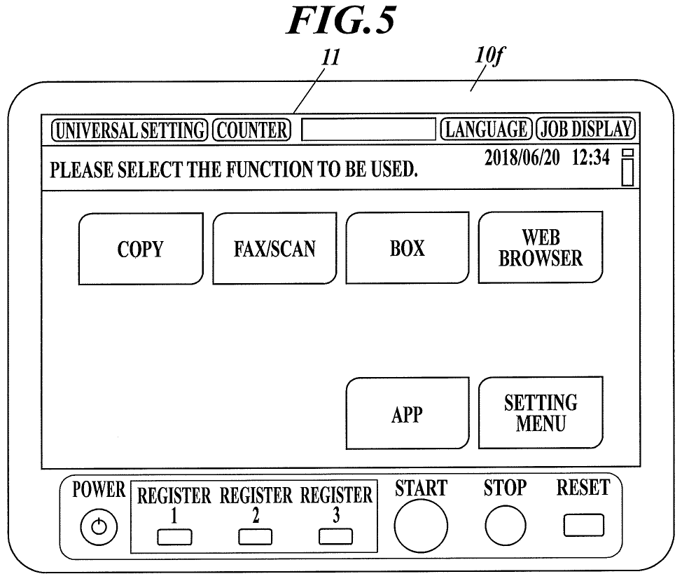

FIG. 5 is a diagram showing an example of a display screen 11 displayed on the touch panel display 10e of the image processing apparatus 1. Buttons showing the functions included in the image processing apparatus 1 such as copy and scan are displayed on the display screen 11, and when the user operates the image processing apparatus 1 to use the function, the user presses the various buttons so as to be able to instruct the start of the function or to set the conditions.

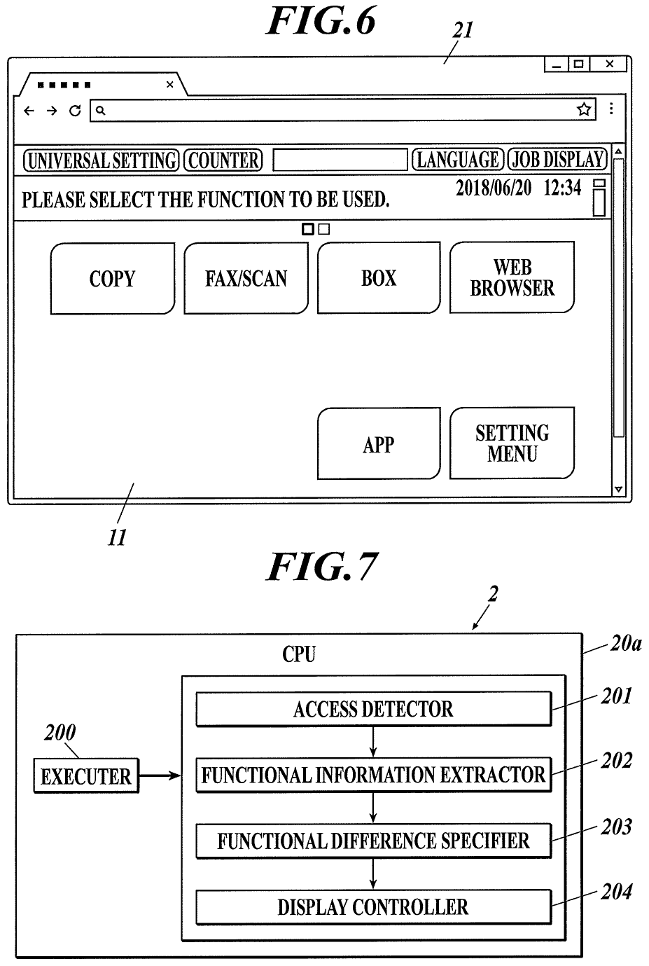

The display screen can be displayed through the Web browser as described above. Therefore, the display screen can be viewed on the PC 2 including the Web browser function with a method similar to access to a normal Web page. FIG. 6 is a diagram showing an example of the display screen 11 displayed on the Web page 21 through the Web browser of the PC 2.

Access to the screen information of a specific image processing apparatus 1 is possible by input of a specific URL represented by IP information of the specific image processing apparatus 1 or by reading with the barcode reader. Therefore, according to the present embodiment, the display screen can be viewed on the PC 2 without using an application dedicated to using the function of the image processing apparatus 1.

Since the PC 2 is able to access to screen information for a plurality of image processing apparatuses 1 at the same time, similar to a normal Web page, the display screens 11 can be displayed in different tabs or different windows for each image processing apparatus 1. Alternatively, a different Web page can be displayed on each display screen. In this case, the screen information can include a description to provide a child browser for the other image processing apparatuses 1, and the URL can be input in the child browser to display the plurality of display screens in the same tab in parallel.

[Screen Information Analysis]

Below, the screen information analysis according to the present embodiment is described with reference to the drawings.

The screen information analysis is a process in which the functional information of the image processing apparatus is analyzed from the screen information of the image processing apparatus 1 transmitted to the terminal apparatus and the functional difference from other image processing apparatuses 1 is specified. Then, the result is displayed on the display screen.

Here, the functional difference means whether a function exists or not depending on the difference in the configuration, such as the difference in the peripheral equipment of the image processing apparatus 1 and the options that can be connected to the image processing apparatus 1 (expansion cassettes, post-processors which perform stapling or punching). For example, one image processing apparatus 1 is connected to the post-processor and includes the “stapling/punching function” whereas the other image processing apparatus 1 does not include a post-processor and therefore, such functions cannot be used.

The screen information is a document for generating the display screen 11 described in a language such as HTML or JavaScript as described above. This includes the description to display the buttons corresponding to the functional items (copying, scanning, etc.) included in the image processing apparatus 1 on the display screen 11 as shown in FIG. 5. Therefore, by reading the description from the screen information, the functions included in the image processing apparatus 1 can be understood.

The functional differences among the image processing apparatuses 1 can be understood by including in the screen information of the one image processing apparatus 1 the program (information analysis program) to extract and analyze the information regarding the function (functional information) from the screen information of other image processing apparatuses 1 viewed on the PC 2 at the same time.

Specifically, the information analysis program is the program to perform a specific event process described by JavaScript.

FIG. 7 is a diagram showing a functional configuration of the PC 2. The CPU 20a functions as an executor 200 which executes the information analysis program. The information analysis program executed by the executor 200 allows the CPU 20a of the PC 2 which accesses to the screen information to function as an access detector 201, functional information extractor 202, functional difference specifier 203, and display controller 204 as shown in FIG. 7. With this, the screen information analysis is executed.

Specifically, the following screen information analysis is executed.

The information analysis program included in the screen information of the image processing apparatus 1A describes an example in which the functional information of the image processing apparatus 1B is analyzed.

The information analysis program of the image processing apparatus 1A allows the CPU 20a to function as the functional information extractor 202, and the description to display the functional items is determined from the screen information of the image processing apparatus 1A. With this, the functional information is extracted and the functions included in the image processing apparatus 1A are analyzed. Specifically, when there is a description to display the copying button in the screen information, the description is extracted, and it is determined that the image processing apparatus 1A includes the copying function.

In this state, when the user inputs the URL of the image processing apparatus 1B, the information analysis program of the image processing apparatus 1A allows the CPU 20a to function as the access detector 201 and detects the access to the screen information of the image processing apparatus 1B. Specifically, the information analysis program refers to the URL information input in the different tab (child browser when the plurality of display screens are displayed in the same tab). When the specific URL representing the display screen 11 is determined (for example, http:///<IP address of image processing apparatus 1B><TOP>), the access to the image processing apparatus 1B is detected.

Next, the information analysis program of the image processing apparatus 1A allows the CPU 20a to function as the functional information extractor 202, and extracts the functional information by determining the description to display the functional items from the screen information of the image processing apparatus 1B.

Next, the information analysis program allows the CPU 20a to function as the functional difference specifier 203 and compares the functional information of the image processing apparatus 1A with the functional information of the image processing apparatus 1B to specify the functional difference.

Further, the information analysis program allows the CPU 20a to function as the display controller 204 and determines from the specified functional difference whether there is a function included only in the image processing apparatus 1A. If there is such function, a flag is set to emphasize the function. The emphasized flag displays the function with emphasis on the display screen 11A displayed on the display 20g. As the method to display with emphasis, in addition to surrounding only the button portion of this function with a colored frame, methods such as enlarging the icon size, enlarging the character size, changing the thickness or color, displaying in a popped up state or displaying in a blinking state are effective.

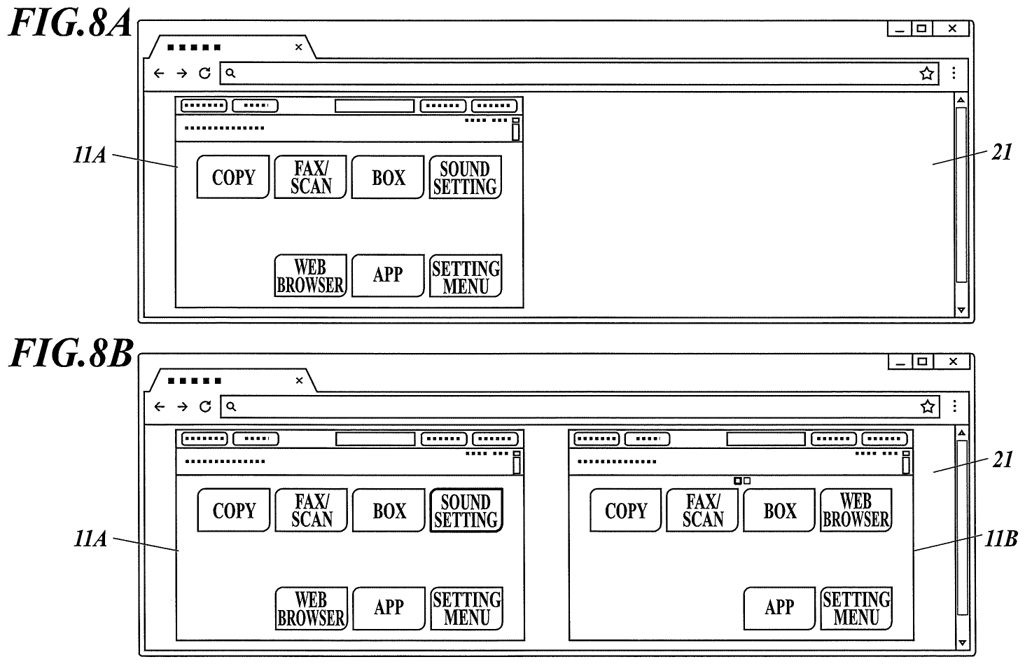

FIG. 8 is a diagram showing an example of the Web page 21. FIG. 8 is an example displaying the plurality of display screens in the same tab.

As shown in FIG. 8A, the user accesses to the screen information of the image processing apparatus 1A and the display screen 11A of the image processing apparatus 1A is displayed on the Web page 21. When the user accesses to the screen information of the image processing apparatus 1B in this state, the screen information analysis is performed. As shown in FIG. 8B, the display screen 11B of the image processing apparatus 1B is displayed on the Web page 21 with two screens, and only the button portion of the “sound setting” function specific to the image processing apparatus 1A is surrounded by a colored frame to be displayed with emphasis.

[Operation of Image Processing System]

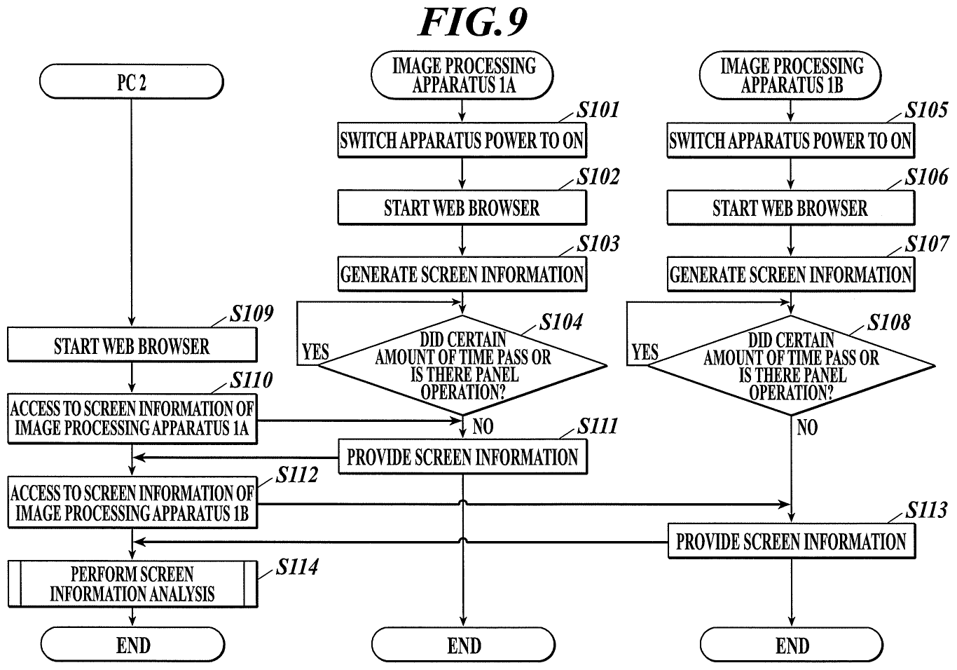

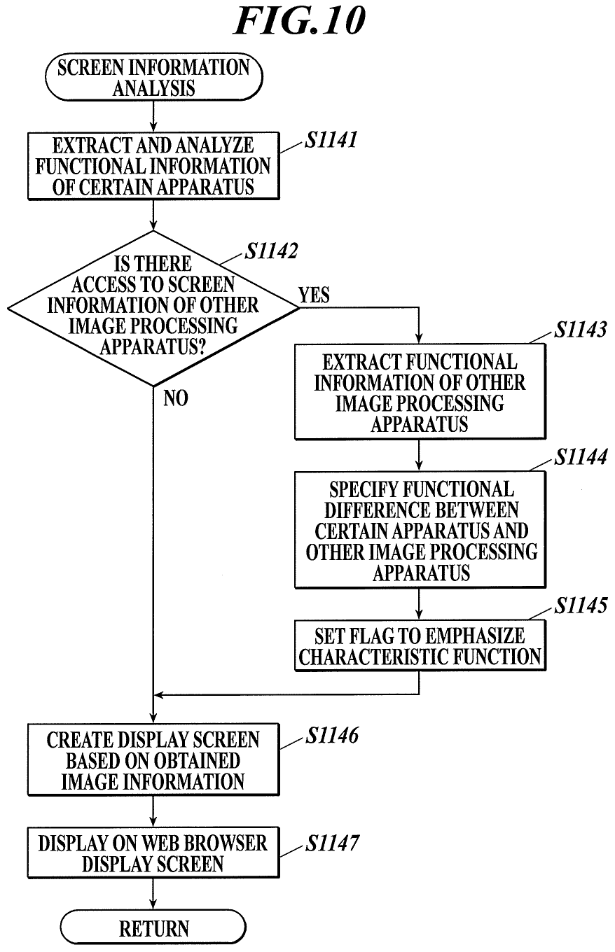

Next, the operation of the image processing system 100 according to the present embodiment is described based on the flowchart shown in FIG. 9. The example described below assumes displaying the functions specific to the image processing apparatus 1A with emphasis based on the screen information of the image processing apparatus 1A when the PC 2 accesses to the image processing apparatus 1A and the image processing apparatus 1B connected to the communication line 4.

First, the power of the image processing apparatus 1A is turned on (step S101), and when the Web browser of the image processing apparatus 1A is started (step S102), the image processing apparatus 1A generates the screen information (step S103).

Next, the image processing apparatus 1A determines whether a certain amount of time passed or the user touched the touch panel display 10e (step S104). If it is determined that a certain amount of time passed or the user performed an operation (step S104: YES), the process returns to step S103 and the screen information is regenerated. If it is determined that the situation is neither of the above (step S104: NO), the screen information is not regenerated.

That is, the screen information is generated when the Web browser is started after the power of the image processing apparatus 1A is turned on and is updated when a certain amount of time passes or the user performs the operation.

In the image processing apparatus 1B, the screen information is generated. The process in steps S105 to S108 in the image processing apparatus 1B is similar to the processes in steps S101 to S104. Therefore, the description is omitted.

In the PC 2, the Web browser is started (step S109), and when the user of the PC 2 accesses to the screen information by inputting the URL of the image processing apparatus 1A, for example (step S110), the image processing apparatus 1A provides the screen information to the PC 2 (step S111).

Next, when the user of the PC 2 accesses to the screen information of the image processing apparatus 1B (step S112), the image processing apparatus 1B provides the screen information to the PC 2 (step S113).

Next, the screen information analysis is performed on the PC 2 (step S114).

The operation of the screen information analysis is described based on the flowchart shown in FIG. 10. The screen information analysis is realized by the CPU 20a as the executor 200 of the PC 2 in coordination with the information analysis program included in the screen information of the image processing apparatus 1A.

First, as the functional information extractor 202, the CPU 20a of the PC 2 extracts the functional information of a certain apparatus and analyzes the information (step S1141). Here, “certain apparatus” means the image processing apparatus 1A.

Next, as the access detector 201, the CPU 20a determines whether there is access to the screen information of the other image processing apparatus (step S1142). Here, “the other image processing apparatus” means the image processing apparatus 1B.

If the CPU 20a does not detect access (step S1142: NO), the process progresses to step S1146. If the CPU 20a detects access (step S1142: YES), the CPU 20a extracts the functional information from the screen information of the other image processing apparatus as the functional information extractor (step S1143), specifies the functional difference between the certain apparatus and the other image processing apparatus 1 as the functional difference specifier 203 (step S1144), and sets the flag in the description to display characteristic functions such as the function unique to the certain apparatus as the display controller 204 (step S1145).

In step S1146, the display screen is generated based on the obtained screen information. In step S1147, the display screen 11 is displayed on the Web page 21 of the PC 2, and the screen information analysis ends.

When the screen information analysis ends, the control as shown in FIG. 9 ends.

As described above, the image processing apparatus 1 according to the present embodiment provides the screen information to the terminal apparatus and provides the display screen by a Web browser of the terminal apparatus. The screen information includes the functional information showing the functions included in the image processing apparatus 1. The screen information also includes the information analysis program which controls the computer of the terminal apparatus to function as the functional information extractor which extracts the functional information of the image processing apparatus 1 from the screen information, the access detector which detects access of the terminal apparatus to other image processing apparatuses, the functional difference specifier which specifies the functional difference between the image processing apparatus and the other image processing apparatus based on the functional information and a display controller which displays the functional difference on the display screen.

Therefore, the user does not need to bear the burden of installing the application dedicated to the terminal apparatus. The user is able to confirm the difference in functions among the image processing apparatuses 1 through the Web browser. This is convenient for the user.

Moreover, the screen information according to the present embodiment is described in a language to create a Web page. Such language includes HTML or JavaScript. Therefore, the display screen of the image processing apparatus 1 can be viewed with a terminal apparatus including the Web browser without installing a dedicated application.

According to the present embodiment, the functional difference is defined as whether a certain function exists depending on the difference in the configuration of the image processing apparatus 1, but the present invention is not limited to the above.

The functional difference may be a difference in the performance for the same function instead of whether a function exists or not. For example, in functions such as copying or scanning, the speed (high speed/low speed) may be important to the user, and when there is a difference in the performance of the same function, it may not always be optimal to display with emphasis based on only whether the function exists or not.

Therefore, it is effective to display with emphasis when the performance of the function is preferable to the user based on the performance such as, difference in speed of copying/scanning, the difference in resolution (high resolution/low resolution), maximum number of sheets that can be printed which can be specified from the information regarding the number of cassettes and the sheet storage amount. Specifically, it is assumed that, the description regarding the performance is extracted from the screen information, and when the certain apparatus has a higher performance than the other image processing apparatus (copying/scanning speed is faster, higher resolution, larger maximum printable number), the performance is displayed with emphasis as the feature of the image processing apparatus 1.

According to the present embodiment, the display screens of a plurality of image processing apparatuses 1 are displayed in the same tab. Therefore, the tab does not need to be switched for each image processing apparatus 1. Consequently, the convenience for the user is enhanced, and the user can easily see the display.

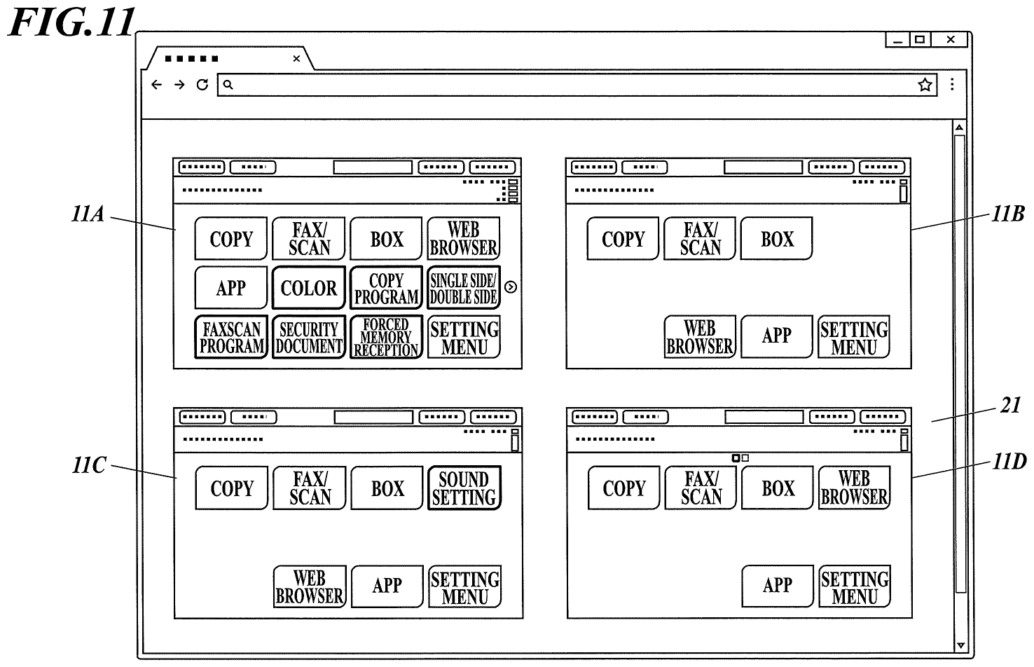

According to the present embodiment, the display screen of two image processing apparatuses 1 are displayed aligned, but the number is not limited. For example, as shown in FIG. 11, when there is access to four image processing apparatuses shown as image processing apparatuses 1A, 1B, 1C, and 1D, each display screen (display screens 11A to 11D) can be displayed aligned. FIG. 11 shows the function existing in only each image processing apparatus 1 among the four image processing apparatuses displayed with emphasis by a colored frame on the display screen 11.

According to the present embodiment, the PC 2 is used as the terminal apparatus, but even if the portable terminal 3 or the other image processing apparatus 1 is used as the terminal apparatus, the present invention can be applied.

That is, the display screen displayed in the touch panel display 10e of one of the image processing apparatuses 1 can be displayed in the touch panel display 30d of the portable terminal 3 or the touch panel display 10e of the other image processing apparatus 1. In this case, since the size of the display is small, each display screen becomes small if a plurality of display screens are displayed. As a result, it becomes difficult to understand each item.

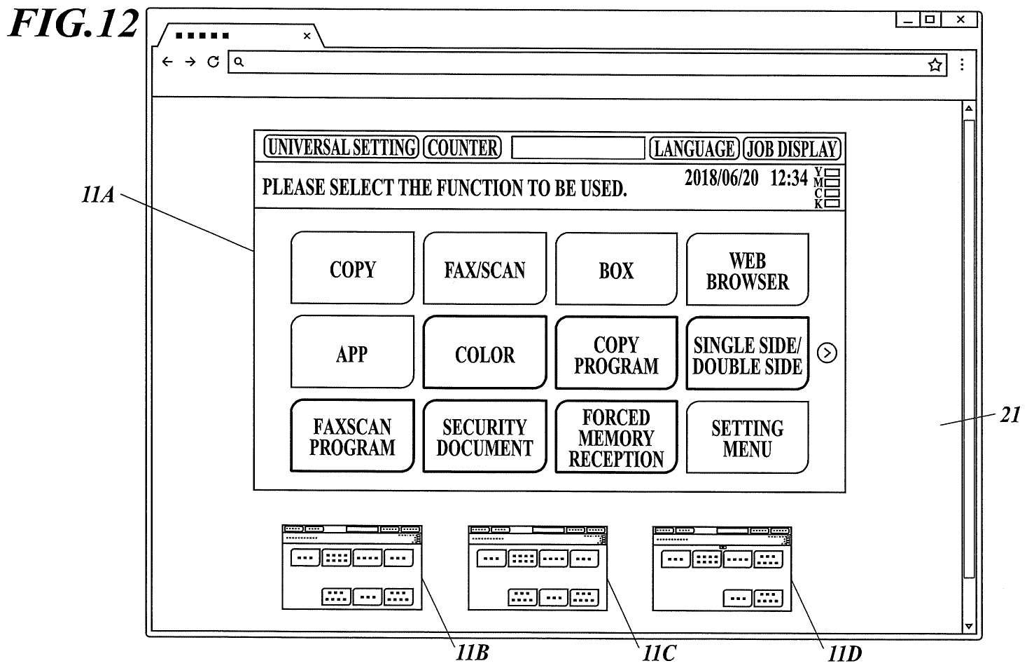

In view of the above, as shown in FIG. 12, an effective display is that the apparatus classifies the display screens between the display screen of the certain apparatus (display screen 11A) and the display screens of the other image processing apparatuses 1 (display screens 11B to 11D) and the apparatus displays the display screen of the other image processing apparatuses 1 in a reduced display to match the display size of the Web page 21.

### Second Embodiment

The second embodiment of the image processing system is described with reference to the drawings. The present invention is not limited to the illustrated examples.

According to the first embodiment, the apparatus displays with emphasis the functions unique to the certain apparatus (image processing apparatus 1A). However, according to the present embodiment, when the number of image processing apparatuses 1 which include a certain function among the image processing apparatuses 1 being accessed is a predetermined number or less, the function is displayed with emphasis.

Specifically, when the terminal apparatuses accesses to an n-number of image processing apparatuses 1, if there is a function which exists in only a x-number of image processing apparatuses 1 or less, the function is displayed with emphasis. If the threshold x can be set freely, the options for comparison increase. The threshold x may be changed depending on the value n.

[Screen Information Analysis]

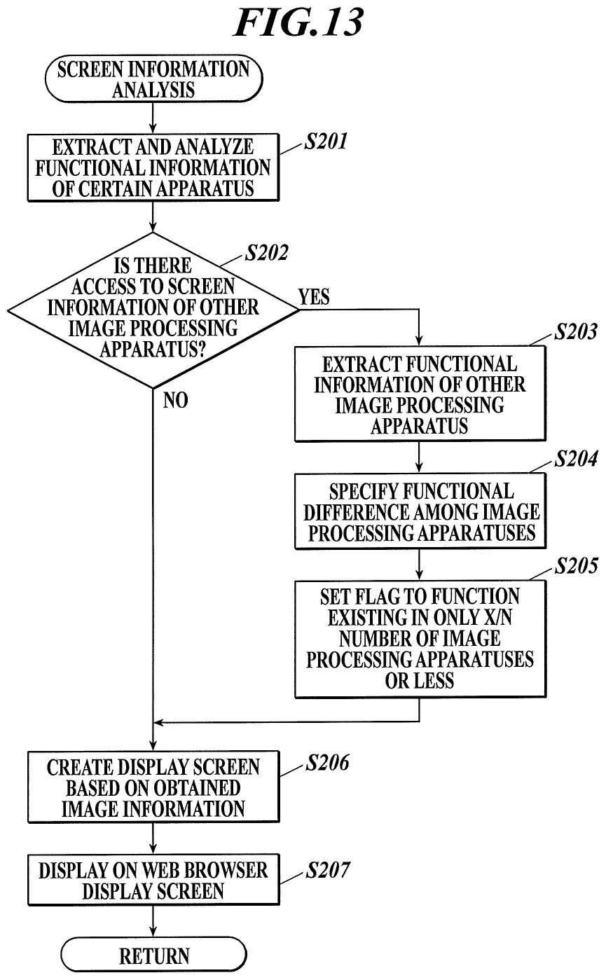

The operation in the screen information analysis is described with reference to the flowchart shown in FIG. 13. According to the present embodiment, the PC 2 is used as the terminal apparatus, and the screen information analysis is performed by the CPU 20a of the PC 2 in coordination with the information analysis program included in the screen information of the image processing apparatus 1A.

The processes of steps S201 to S203 are similar to the processes in steps S1141 to S1143, and the description is omitted.

In step S204, the CPU 20a of the PC 2 functions as the functional difference specifier 203 to compare the functional information of all of the image processing apparatuses 1 being accessed to specify the functional difference (step S204). As described above, the functional difference may be the difference of whether the function exists or not or the difference in the performance of the same function.

Next, the CPU 20a sets a flag in the function which exists only in the x/n number of image processing apparatuses 1 or less (step S205). As described above, n is the number of image processing apparatuses 1 being accessed and x is a threshold which can be set to any value. With this, the functions existing in only the x number of image processing apparatuses 1 or less are displayed with emphasis.

Next, the display screen 11 is generated based on the obtained screen information (step S206), and the Web page 21 of the PC 2 is displayed on the display screen 11. With this, the screen information analysis ends.

As described above, according to the present embodiment, among the functions included in the image processing apparatuses 1 connected to the terminal apparatus, the functions included in only a predetermined number of image processing apparatuses 1 or less are specified, and the functions are displayed with emphasis. Therefore, by setting the threshold to any value, the options for comparison increase. With this, the convenience of the user is enhanced.

The present invention is described in detail according to the embodiments. The detailed configuration of the apparatuses and the detailed operation of the apparatuses included in the image processing system can be suitably changed without leaving the scope of the present invention.

According to the above description, an HDD or a semiconductor nonvolatile memory are used as the computer-readable storage medium including the program of the present invention, but the present invention is not limited to the above. Portable storage mediums such as a CD-ROM can be used as the computer-readable medium. The data of the program according to the present invention can be provided through communication lines by applying carrier waves.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-127220 filed on Jul. 4, 2018 is incorporated herein by reference in its entirety.

What is claimed is:

1. An image processing apparatus which includes a function to perform a process based on a request from a terminal apparatus, the image processing apparatus comprising:
a communicator which performs data communication with the terminal apparatus; and
a hardware processor which provides through the communicator to the terminal apparatus screen information to form a display screen displayed on a display of the image processing apparatus, and which displays the display screen with a browser of the terminal apparatus,
wherein, the screen information includes,
functional information which shows a function included in the image processing apparatus; and
an information analysis program which allows a computer of the terminal apparatus to function as a functional information extractor which extracts functional information of the image processing apparatus from the screen information, a functional difference specifier which specifies the functional difference between the image processing apparatus and another image processing apparatus based on the functional information, and a display controller which controls the display to display the functional difference on the display screen.

2. The image processing apparatus according to claim 1, wherein,
the information analysis program allows the computer of the terminal apparatus to function as an access detector which detects access from the terminal apparatus to the other image processing apparatus, and
the functional information extractor extracts the functional information of the other image processing apparatus in response to the access detector detecting access to the other image processing apparatus.

3. The image processing apparatus according to claim 1, wherein the screen information is described in a language to create a web page.

4. The image processing apparatus according to claim 1, wherein the functional difference specifier specifies whether there is a difference in the function included in the image processing apparatus due to a difference in a configuration of the image processing apparatuses.

5. The image processing apparatus according to claim 1, wherein the functional difference specifier specifies a difference in performance of a function included in the image processing apparatus and specifies a difference in performance in at least one among printing speed of the image processing apparatus, scanning speed, resolution, and maximum printable number.

6. The image processing apparatus according to claim 1, wherein the functional difference specifier specifies a function included in only a predetermined number of image processing apparatuses or less among the functions included in the image processing apparatus connected to the terminal apparatus.

7. The image processing apparatus according to claim 1, wherein the display controller displays on the browser of the terminal apparatus the display screen of the plurality of image processing apparatuses collectively on one screen.

8. The image processing apparatus according to claim 7, wherein the display controller changes the size of the display screen of the plurality of image processing apparatuses displayed on one screen according to a screen size and/or a resolution of the terminal apparatus.

9. An image processing system comprising:
a terminal apparatus; and
an image processing apparatus which includes a function to perform a process based on a request from the terminal apparatus,
wherein the image processing apparatus includes:
a communicator which performs data communication with the terminal apparatus; and
a hardware processor which provides through the communicator to the terminal apparatus screen information to form a display screen displayed on a display of the image processing apparatus, and which displays the display screen with a browser of the terminal apparatus,
wherein,
the screen information includes,
functional information which shows a function included in the image processing apparatus; and
an information analysis program which allows a computer of the terminal apparatus to function as a functional information extractor which extracts functional information of the image processing apparatus from the screen information, a functional difference specifier which specifies the functional difference between the image processing apparatus and another image processing apparatus based on the functional information, and a display controller which controls the display to display the functional difference on the display screen, and
the terminal apparatus performs the information analysis program included in the screen information.

10. A non-transitory computer-readable storage medium having a program stored thereon for controlling a computer in an image processing apparatus which includes a function to perform a process based on a request from a terminal apparatus and a communicator which performs data communication with the terminal apparatus, wherein the program controls the computer to perform:
providing through the communicator to the terminal apparatus screen information to form a display screen displayed on a display of the image processing apparatus, and
displaying the display screen with a browser of the terminal apparatus,
wherein, the screen information includes,
functional information which shows a function included in the image processing apparatus; and
an information analysis program which allows a computer of the terminal apparatus to function as a functional information extractor which extracts functional information of the image processing apparatus from the screen information, a functional difference specifier which specifies the functional difference between the image processing apparatus and another image processing apparatus based on the functional information, and a display controller which controls the display to display the functional difference on the display screen.
